(19) United States
(12) Patent Application Publication
(10) Pub. No.: US 2023/0045957 A1
(43) Pub. Date: Feb. 16, 2023

(54) MULTI-SOURCE LIGHT-GUIDING ILLUMINATOR

(71) Applicant: Facebook Technologies, LLC, Menlo Park, CA (US)

(72) Inventors: Fenglin Peng, Redmond, WA (US); Ying Geng, Bellevue, WA (US); Lu Lu, Kirkland, WA (US); Yun-Han Lee, Redmond, WA (US); Jacques Gollier, Sammamish, WA (US)

(21) Appl. No.: 17/401,069

(22) Filed: Aug. 12, 2021

(51) Int. Cl. G02B 27/01

(52) U.S. Cl. CPC G02B 27/0101; G02B 27/0172; G02B 2027/0123; G02B 2027/0105

(57) ABSTRACT

An illuminator usable for illuminating a display panel is disclosed. The illuminator uses a pupil-replicating waveguide to expand a pair of light beams propagating in the waveguide. The light beams may be coupled at a same edge and/or at opposite edges of the waveguide, and are configured to fill each other's dark spots between out-coupled beam portions of the light beams. To improve the illumination uniformity, the two light beams may be orthogonally polarized, and the out-coupling grating strength may be spatially varied along the waveguide.

### TECHNICAL FIELD

The present disclosure relates to illumination devices, and in particular to illuminators usable in visual display systems, and related methods.

### BACKGROUND

Visual displays provide information to viewer(s) including still images, video, data, etc. Visual displays have applications in diverse fields including entertainment, education, engineering, science, professional training, advertising, to name just a few examples. Some visual displays, such as TV sets, display images to several users, and some visual display systems, such s near-eye displays or NEDs, are intended for individual users.

An artificial reality system generally includes an NED (e.g., a headset or a pair of glasses) configured to present content to a user. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by seeing through a “combiner” component. The combiner of a wearable display is typically transparent to external light but includes some light routing optic to direct the display light into the user's field of view.

Because a display of HMD or NED is usually worn on the head of a user, a large, bulky, unbalanced, and/or heavy display device with a heavy battery would be cumbersome and uncomfortable for the user to wear. Head-mounted display devices require compact and efficient illuminators that provide a uniform, even illumination of a display panel or other objects or elements in the display system.

### BRIEF DESCRIPTION OF THE DRAWINGS

Exemplary embodiments will now be described in conjunction with the drawings, in which:

FIG. 1 is a side cross-sectional view of a waveguide-based illuminator of this disclosure with a single directional source of light;

FIG. 2 is a side cross-sectional view of a waveguide-based illuminator of this disclosure with a pair of directional sources of light at opposite ends of the waveguide;

FIG. 3A is a schematic view of an illumination waveguide illustrating light propagation in the illumination waveguide;

FIG. 3B shows plots of the illumination distribution along the waveguide of FIG. 3A;

FIG. 4 is a side cross-sectional view of a waveguide-based illuminator of this disclosure with a dual light source for co-propagating two beams of light in the waveguide;

FIG. 5 is a side cross-sectional view of a waveguide-based illuminator of this disclosure with a pair of directional sources edge-coupled to opposite ends of the waveguide;

FIG. 6 is a thickness plot vs. waveguide length coordinate of a polarization volume hologram (PVH) used as an out-coupler of a waveguide-based illuminator of FIG. 4;

FIG. 7 is an illumination intensity plot vs. the length coordinate for the waveguide-based illuminator of FIG. 6;

FIG. 8 is a side cross-sectional view of a display device of this disclosure;

FIG. 9 is a flow chart of a method for illuminating a display panel in accordance with this disclosure;

FIG. 10 is a view of an augmented reality (AR) display of this disclosure having a form factor of a pair of eyeglasses; and

FIG. 11 is a three-dimensional view of a head-mounted display (HIVID) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

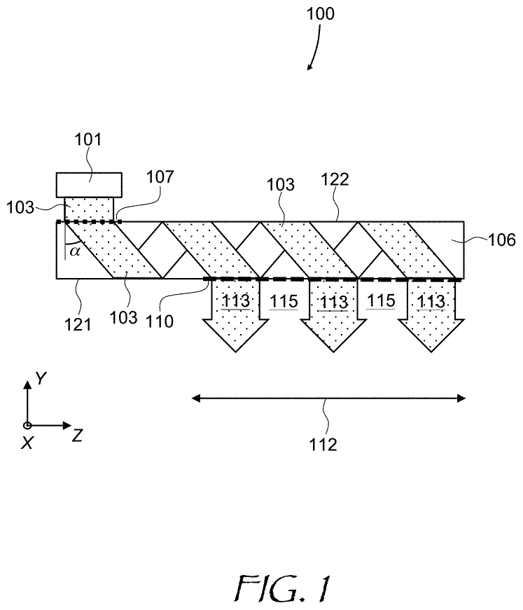

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1, 2, 3A, 4, and 5, similar reference numerals denote similar elements.

An illuminator may use a pupil-replicating waveguide to expand the illuminating beam across a surface area to be illuminated such as a display panel, for example. The replicating waveguide expands the illuminating beam by bouncing off opposed parallel surfaces of the waveguide, which may include, for example, a plano-parallel plate. The illuminating beam propagates in the waveguide, and portions of the illuminating beam are out-coupled along the waveguide's length dimension by an out-coupler, typically a grating structure coupled to one of the parallel surfaces.

For efficiency reasons, it may be desirable to increase the angle of propagation of the light inside the waveguide. The angle of propagation may be selected to be large enough such that the beam of light clears the in-coupling structure upon first reflection. Unfortunately, larger angles of propagation may cause illumination intensity drops to appear along the waveguide. This happens because the locations where the propagating light beam illuminates the grating out-coupler may be spaced apart too far, such that no light is out-coupled out of the waveguide between these locations.

In accordance with this disclosure, the problem of dark locations and/or non-uniformity of illumination provided by a waveguide-based illuminator may be mitigated by using at least a pair of light beams in-coupled and co-propagating in the waveguide. The light beams may be coupled at a same edge and/or at opposite edges of the waveguide, and may be configured to fill each other's dark spots between out-coupled beam portions. To further improve the illumination uniformity, the out-coupling grating strength and/or grating thickness may be spatially varied along the waveguide. The two beams may be in-coupled at orthogonal polarizations to suppress optical interference between them. Furthermore, a low coherence length light source may be selected to provide the light beams propagating in the waveguides. The coherence length may be lower than an optical path length difference between neighboring light paths in the waveguide.

In accordance with the present disclosure, there is provided an illuminator comprising a slab of transparent material for in-coupling the first and second light beams into the slab for propagation therein by a series of zigzag reflections from opposed surfaces of the slab along a length dimension of the slab. An out-coupler is provided for out-coupling offset parallel portions of the first and second light beams from the slab along the length dimension. The first light beam portions are offset from one another by a series of gaps spaced along the length dimension, and the second light beam portions are offset from one another by a series of gaps spaced along the length dimension. The gaps between the first light beam portions overlap with the second light beam portions, and the gaps between the second light beam portions overlap with the first light beam portions, for providing a continuous illumination along the length dimension.

In some embodiments, a diameter D of the first and second light beams, a thickness t of the slab between the opposed surfaces, and an angle α of the first and second light beams w.r.t. a normal to the first and second surfaces are selected satisfy the condition t*tan(α)≥D. In some embodiments, full width at half maximum (FWHM) of the gaps between the first light beam portions may be substantially equal to a FWHM of the second light beam portions, and a FWHM of the gaps between the second light beam portions may be substantially equal to a FWHM of the first light beam portions. The first and second light beams emitted by the light source may be orthogonally polarized to reduce optical interference effects.

The out-coupler of the illuminator may include a polarization volume grating (PVH), a volume Bragg grating (VBG), and/or a surface-relief grating (SRG). In embodiments where the out-coupler comprises a PVH, the first and second light beams emitted by the light source may be orthogonally circularly polarized. A thickness of the PVH may vary along the length dimension of the slab for evening out optical power density of the illumination provided by the illuminator along the length dimension of the slab. A coherence length of the light source may be selected to be less than an optical path difference between neighboring optical paths of the first and second light beams, to reduce optical interference effects.

In some embodiments, the light source comprises a directional source for providing a directed light beam, and a grating coupled to the directional source for splitting the directed light beam into the first and second light beams at an angle to each other for joint propagation in the slab generally in a same direction along the length dimension of the slab. The grating may be tunable in pitch.

In embodiments where the light source comprises first and second directional sources for providing the first and second light beams respectively, the first and second light beams may be coupled at opposite edges of the slab to propagate towards each other. In such embodiments, first and second directional sources may be configured for edge-coupling the first and second light beams, respectively, into the slab to propagate towards each other.

In accordance with the present disclosure, there is provided a display device including a display panel for providing an image in linear domain and an illuminator described herein. An ocular lens may be provided for converting the image in linear domain into an image in angular domain to be directly observed by a user's eye placed at an eyebox of the display.

In accordance with the present disclosure, there is further provided a method for illuminating a display panel. The method includes using a light source to provide first and second light beams, in-coupling the first and second light beams into a slab of transparent material, propagating the first and second light beams in the slab by a series of zigzag reflections from opposed surfaces of the slab along a length dimension of the slab, and out-coupling offset parallel portions of the first and second light beams from the slab along the length dimension. The first light beam portions are offset from one another by a series of gaps spaced along the length dimension, and the second light beam portions are offset from one another by a series of gaps spaced along the length dimension. The gaps between the first light beam portions overlap with the second light beam portions, and the gaps between the second light beam portions overlap with the first light beam portions, for providing a continuous illumination of the display panel along the length dimension.

In some embodiments, a diameter D of the first and second light beams, a thickness t of the slab between the opposed surfaces, and an angle α of the first and second light beams w.r.t. a normal to the first and second surfaces satisfy the condition D≥t*tan(α). The first and second light beams emitted by the light source may be orthogonally polarized to reduce unwanted optical interference and fringing. The first and second light beams may propagate in the slab in a same direction or towards each other.

Referring now to FIG. 1, an illuminator 100 includes a directional light source 101 for providing a light beam 103, and a slab 106 of transparent material for propagating the light beam 103 in the slab 106. Herein, the term “directional light source” denotes a light source that produces a directed light beam as opposed to scattered light, e.g. a collimated light beam, or a beam of a non-zero divergence or convergence such as a fundamental mode or a higher mode or a multimode Gaussian light beam, for example. The slab 106 includes an in-coupling grating 107, shown with dotted lines, for in-coupling the light beam into the slab 106, and an out-coupling grating 110, shown with dashed lines, for out-coupling portions 113 of the light beam 103 along a length dimension 112 of the slab 106, which is parallel to the Z-axis in FIG. 1. In operation, the light beam 103 propagates in the slab 106 by of zigzag reflections from opposed first 121 and second 122 surfaces of the slab 106 along the length dimension 112 of the slab 106. In other words, the optical path of the light beam 103 is a zigzag optical path formed by reflections from the surfaces 121 and 122, e.g. total internal reflections (TIRs) of the slab 106. Gaps 115, exist between the out-coupled portions 113 of the light beam 103. The gaps 115 are areas where the out-coupled portions 113 of the light beam 103 is not present. Width of the gaps 115 in Z-direction may be reduced by reducing an in-coupling angle α of the light beam 103 into the slab 106. However, it may be difficult to completely eliminate the gaps 115 in the configuration of the illuminator 100 presented in FIG. 1. The reduction of the in-coupling angle α for the out-coupled portions 113 to become overlapped would cause a portion of the light beam 103 in-coupled by the in-coupling grating 107 to impinge onto the in-coupling grating 107 after reflecting from the first surface 121, leading to undesired optical losses and/or light scattering.

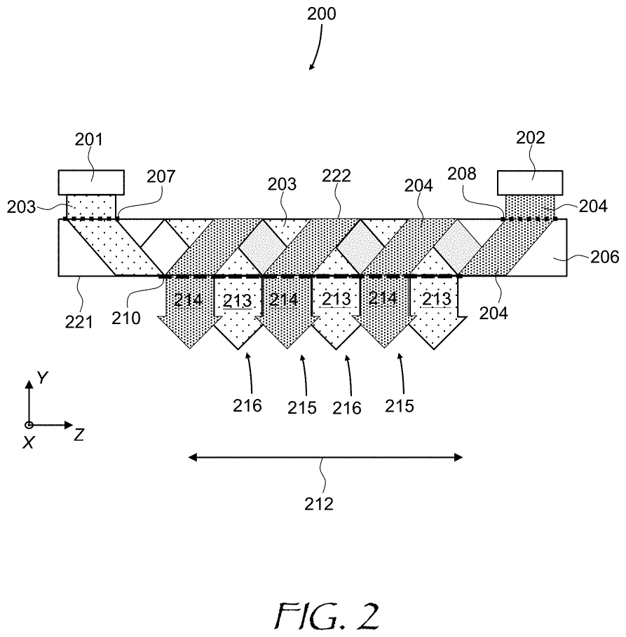

Turning to FIG. 2, an illuminator 200 enables gaps between the portions of out-coupled light to be eliminated. The illuminator 200 includes not one but two directional light sources, specifically first 201 and second 202 directional light sources optically coupled to a slab 206 of a transparent material such as glass, plastic, sapphire, etc., by first 207 and second 208 in-coupling gratings, respectively, disposed at opposite ends of the slab 206. The first 201 and second 202 directional light sources emit first 203 and second 204 light beams respectively by the first 207 and second 208 in-coupling gratings respectively. In some embodiments, the first 201 and second 202 directional light sources may be components of a common light source assembly.

The slab 206 receives the first 203 and second 204 light beams. The first 203 and second 204 light beams propagate in the slab 206 towards each other by a series of reflections, e.g. TIRs, from opposed first 221 and second 222 surfaces of the slab 206 in a zigzag pattern along a length dimension 212 of the slab 206. In FIG. 2, the first light beam 203 is light-shaded, and the second light beam 204 is dark-shaded. The optical path of the first light beam 203 is similar to the optical path of the light beam 103 in the illuminator 100 of FIG. 1. The first light beam 203 propagates inside the slab 206 in a zigzag pattern, portions 213 of the first light beam 203 being out-coupled by an out-coupling grating 210 along the length dimension 212. The portions 213 of the first light beam 203 are offset from one another by a series of gaps 215 spaced along the length dimension 212. The optical path of the second light beam 204 is similar to the optical path of the first light bean 203, only the second light beam 204 propagates in opposite direction along the length dimension 212 (i.e. against Z-axis in FIG. 2) of the slab 206, towards the first light beam 203. The second light beam 204 propagates inside the slab 206 in a zigzag pattern, and portions 214 of the second light beam 204 are out-coupled by the out-coupling grating 210. The portions 214 are offset from one another by a series of gaps 216 spaced along the length dimension 212. The gaps 215 between the first light beam portions 213 overlap with the second light beam 204 portions 214, and the gaps 216 between the second light beam portions 214 overlap with the first light beam 203, ensuring that the illumination provided by the illuminator 200 is continuous, i.e. is absent any gaps, along the length dimension 212. In other words, the first 203 and second 204 light beams fill each other's gaps, causing the output illumination of the illuminator 200 to be more uniform.

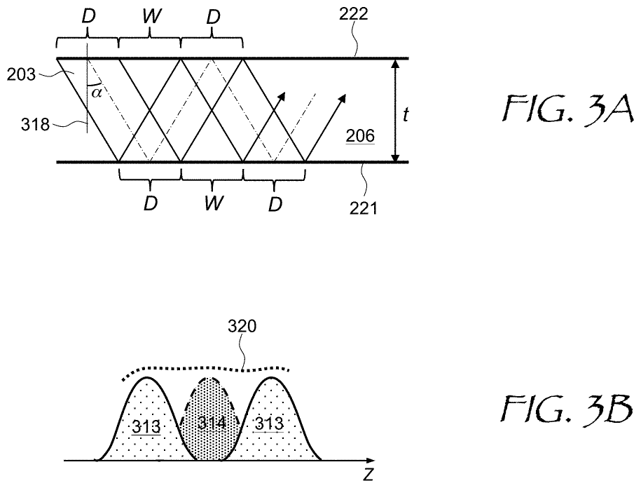

The latter point is illustrated in FIGS. 3A and 3B. Referring first to FIG. 3A with further reference to FIG. 2, the first light beam 203 of the illuminator 200 of FIG. 2 propagates in the slab 206. In FIG. 3A, the slab 206 has a thickness t, the first light beam 203 has a diameter D. The first light beam 203 is in-coupled into the slab 206 at an in-coupling angle α w.r.t. a normal 318 to the first 221 and second 222 surfaces (the first 221 and second 222 surfaces are parallel flat surfaces). The diameter D of the first light bean 203, the thickness t of the slab 206 between the opposed first 221 and second 222 surfaces, and an angle α of the first light bean 203 w.r.t. the normal 318 satisfies the condition

t*tan(α)=D (1)

When condition (1) is fulfilled, the first light beam 203 shifts by two beam diameters D, which means that the width W of the inter-beam gap 215 is equal to D. When the condition (1) is fulfilled for both the first 203 and second 204 light beams, the width of the first light beam portions 213 is equal to the gap 216 between the second light beam portions 214, and vice versa. In other words, the width of the second light beam portions 214 is equal to the gap 215 between the second light beam portions 213, and vice versa. For light beams having a bell-shaped optical power density distribution, such as a Gaussian distribution for a non-limiting example, a full width at half maximum (FWHM) of the gaps 215 between the first light beam portions 213 may be substantially equal to a FWHM of the second light beam portions 214, and a FWHM of the gaps between 216 the second light beam portions 214 may be substantially equal to a FWHM of the first light beam portions 213. Thus, the first 213 and second 214 light beam portions fill each other's gaps, causing the output illumination to be much more uniform. This is illustrated in FIG. 3B, which shows a lateral (Z-direction) optical power density distribution 313 of the first light beam portions 213 superimposed with a lateral (Z-direction) optical power density distribution 314 of the second light beam portions 214, resulting in a smooth overall lateral optical power density distribution 320. In some embodiments, more than two beams are in-coupled into a slab waveguide to fill inter-beam gaps. In such and other embodiments, the beam shift t*tan(α) upon one pair of reflections may be greater than the beam diameter D.

Referring to FIG. 4, an illuminator 400 includes a directional light source 401 and a slab 406 of transparent material including first 421 and second 422 opposed parallel surfaces. The directional light source 401 includes an in-coupling grating 425 showed as a dotted vertical line. The in-coupling grating 425 is coupled to an edge 423 of the slab 406. A directional light beam emitted by the directional light source 401 is split by the in-coupling grating 425 into first 403 and second 404 light beams at an angle to each other. The first light beam 403 is shown in a solid line, and the second light beam 404 is shown in the dashed line. The first 403 and second 404 light beams enter the slab 406 at the edge 423 and co-propagate in the slab 406 generally in a same direction, i.e. Z-direction, along a length dimension 412 of the slab 406. An out-coupler 410, e.g. a diffraction grating, is shown as a horizontal dashed line. The out-coupler 410 is coupled to the first surface 421 of the slab 406. In operation, the out-coupler 410 out-couples first 413 and second 414 offset parallel portions of the first 403 and second 404 light beams, respectively, from the slab 406. The first 413 and second 414 offset parallel beam portions are out-coupled along the length dimension 412. The first light beam portions 413 are offset from one another by a series of gaps spaced along the length dimension 412, and the second light beam portions 414 are offset from one another by a series of gaps spaced along the length dimension 412. The gaps between the first light beam portions 413 overlap with the second light beam portions 414, and the gaps between the second light beam portions 414 overlap with the first light beam portions 413, ensuring a continuous illumination along the length dimension 412, similarly to the configuration of the illuminator 200 of FIG. 2. In other words, the first 413 and second 414 beam portions out-coupled by the out-coupler 410 of FIG. 4 are interleaved and evenly spaced from one another. The in-coupling grating 425 may be tunable in pitch to ensure the above condition of even spacing is fulfilled.

In some embodiments, the in-coupling grating 425 may be a polarization-splitting grating such as, for example, a Pancharatnam-Berry phase (PBP) liquid crystal (LC) grating described in U.S. Pat. No. 10,678,116 B1 entitled “Active Multi-Color PBP Elements” to Lam et al., which is incorporated herein by reference. The PBP LC grating can split the light beam emitted by the light source 401 into right circular polarized (RCP) first light beam 403 and left-circular polarized (LCP) second light beam 404. When the first 403 and second 404 light beams are orthogonally polarized, the neighboring first 413 and second 414 light beam portions are also nearly orthogonally polarized, which reduces their mutual optical interference and resulting fringe patterns, thereby further improving spatial uniformity of the output illumination. More generally, any orthogonal or nearly orthogonal polarizations, linear, circular, elliptical, etc., may be used to reduce mutual interference of the interleaved output beam portions.

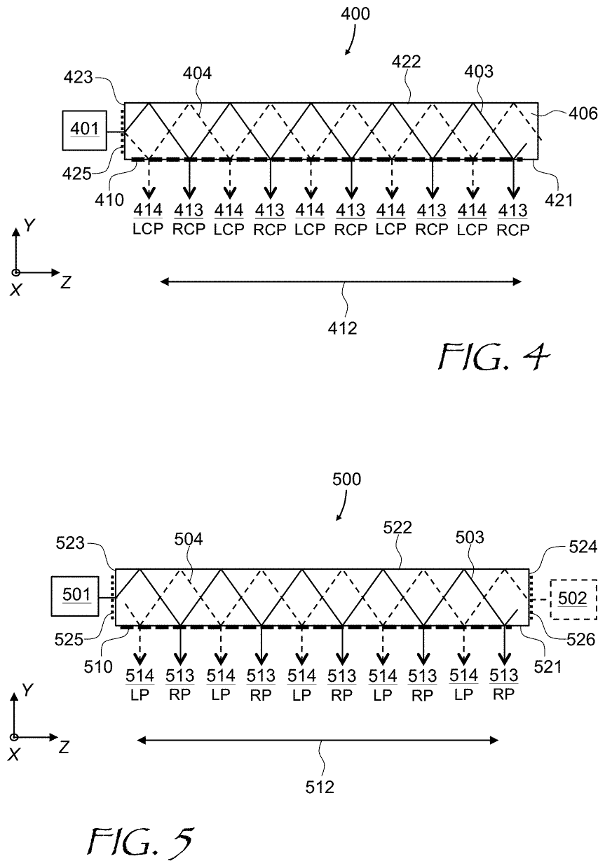

Turning to FIG. 5, an illuminator of FIG. 5 is similar to the illuminator 200 of FIG. 2 and operates in a similar way. The illuminator 500 includes a first directional light source 501 (solid rectangle) and a second directional light source 502 (dashed rectangle), a slab 506 of transparent material having opposed first 521 and second 522 surfaces running parallel to each other, first 525 and second 526 in-coupling gratings at opposed first 523 and second 524 edges of the slab 506, and an out-coupling grating 510 at the first surface 521. In operation, first 503 and second 504 light beams emitted by the first 501 and second 502 directional light sources, respectively, are in-coupled by the first 525 and second 526 in-coupling gratings, respectively, into the slab 506. The first light beam 503 is shown in a solid line, and the second light beam 504 is shown in the dashed line. The first 503 and second 504 light beams propagate towards each other by a series of reflections from the first 521 and second 522 surfaces of the slab 506. Portions 513 of the first light beam 503 and portions 514 of the second light beam 504 are out-coupled by the out-coupling grating 510 along a length dimension 512. The portions 513, 514 are interleaved, filling each other's gaps as explained above. In the embodiment shown, the first 501 and second 502 directional light sources emit orthogonally linearly polarized first 503 and second 504 light beams, such that the output light beam portions 513, 514 are also orthogonally polarized. The orthogonal polarization of the neighboring output light beam portions 513, 514 suppresses their mutual optical interference and resulting fringe patterns, thereby further improving a spatial uniformity of optical power density distribution of the output illumination.

The type of the input grating couplers 107 of FIGS. 1, 207 and 208 of FIG. 2, 425 of FIGS. 4, 525 and 526 of FIG. 5, and the output grating couplers 110 of FIG. 1, 210 of FIG. 2, 410 of FIGS. 4, and 510 of FIG. 5 depends on the required geometrical, polarization, and spectral characteristics of the in-coupled and/or out-coupled light. The gratings may be polarization, wavelength, and angle-selective. For example and without limitations, surface-relief gratings, buried gratings, volume Bragg gratings (VBGs), PBP gratings, and/or polarization volume hologram (PVH) gratings, may be used in any of the above in- and/or out-couplers. PVH gratings have been disclosed e.g. in U.S. Pat. No. 10,935,794 to Amirsolaimani et al., which is incorporated herein by reference.

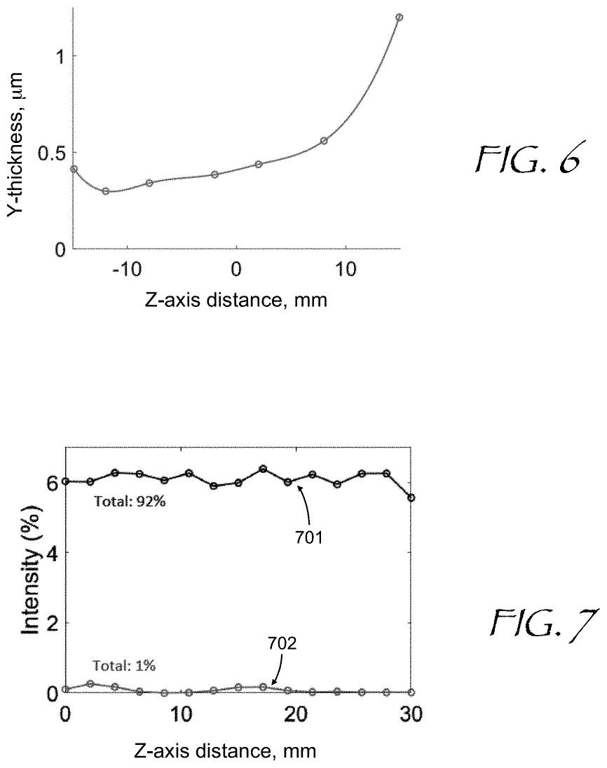

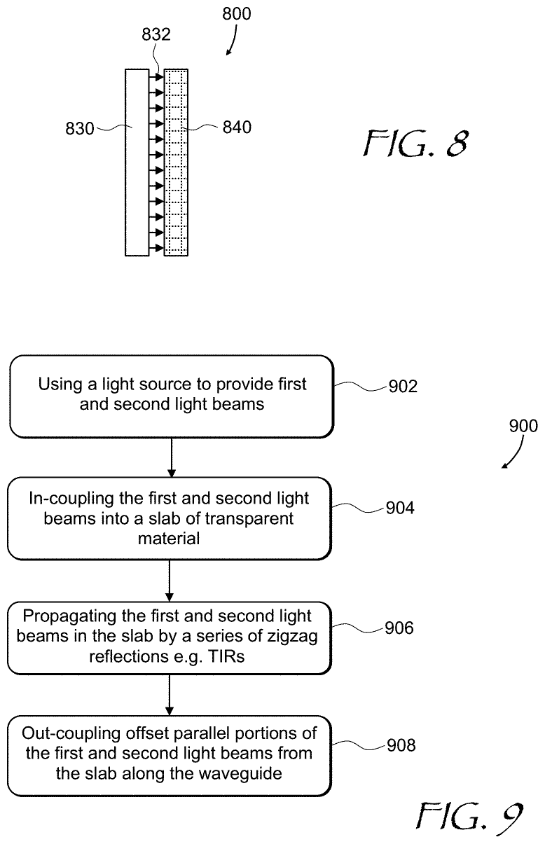

In some embodiments, the strength of the out-coupler grating may be spatially varied to offset illumination non-uniformity inherent to an optical path where a light beam travels within a waveguide and portions of the light beam are out-coupled from the waveguide in sequential manner. As the light beam travels in the waveguide, its optical energy is drained, such that subsequent out-couplings yield less optical power if the out-coupling efficiency is not spatially varied. Due to this effect, the strength of the out-coupling grating needs to be increased along the direction of travel of the light beam to even out the spatial distribution of output illumination's optical power density. Referring to FIG. 6, a PVH grating is used as the out-coupler 410 of the illuminator 400 of FIG. 4. In FIG. 6, a Y-thickness of the PVH grating out-coupler in micrometers is plotted z-axis in millimeters. The PVH grating thickness distribution shown in FIG. 6 results in a computed output intensity distribution 701 shown in FIG. 7, with the light leakage in the opposite direction illustrated at 702. The grating thickness of FIG. 6 generally increases along Z-axis, that is, along the length dimension 412 in FIG. 2, with a small drop in the beginning of the curve. The reason behind this is the polarization change during TIR inside the slab 406. At both glass/air and PVH/air interfaces, light changes its polarization during the TIR. The phase change during TIR at a PVH/air interface is particularly complex since it also depends on the PVH thickness. The thickness of the PVH grating varies along the length dimension 412 of the slab 406 for evening out optical power density of the illumination provided by the illuminator 400 along the length dimension 412 of the slab 406. The thickness of the OVH output coupler may also be varied in any other illuminator configuration disclosed herein. The further reduction of the optical power density non-uniformity of output illumination of the illuminator 400 of FIG. 4 or any other illuminator considered herein may be achieved by making sure that a coherence length of the light source is less than an optical path difference between neighboring optical paths of the light beam(s) provided by the light source(s) used.

The illuminators disclosed herein may be used to illuminate a display panel of a display device. Referring to FIG. 7, a display device 800 includes a display panel 830 for providing an image in linear domain, i.e. an image where a coordinate of a light ray corresponds to coordinate of a pixel of an image to be displayed. An illuminator 840 is optically coupled to the display panel 830 for illuminating the display panel 830 with light 832. The illuminator 100 of FIG. 1, the illuminator 200 of FIG. 2, the illuminator 400 of FIG. 4, and the illuminator 500 of FIG. 5 described above may be used in place of the illuminator 840. The display panel 830 may be a transmissive panel including an array of light valves e.g. LC pixels, or a reflective panel including an array of pixels of variable reflectivity. The reflective configuration is possible because the illuminator 840 may be made transparent or translucent w.r.t. light reflected by the reflective display panel.

Turning to FIG. 9 with further reference to FIG. 2, a method 900 of this disclosure for illuminating a display panel includes using a light source, e.g. a light source including the first 201 and second 202 directional light sources of FIG. 2, to provide (FIG. 9; 902) first and second beams of light, e.g. the first 203 and second 204 light beams in FIG. 2. The first and second light beams are coupled (FIG. 9; 904) into a slab of transparent material, e.g. the slab 206 of FIG. 2. The first and second light beams are then propagated (FIG. 9; 906) in the slab, e.g. the slab 206, by a series of zigzag reflections from opposed surfaces 221, 222 of the slab 206 along the length dimension 212 of the slab 206. Offset parallel portions of the first and second light beams are out-coupled (908) from the slab 206 along the length dimension 212. The first light beam portions 213 are offset from one another by a series of gaps 215 spaced along the length dimension 212, and the second light beam portions 214 are offset from one another by a series of gaps 216 spaced along the length dimension 212. The gaps 215 between the first light beam portions 213 overlap with the second light beam portions 214, and the gaps 216 between the second light beam portions 214 overlap with the first light beam portions 213, thereby providing a continuous illumination of the display panel along the length dimension 212. The method 900 is of course applicable to any other illuminator considered herein that uses two or more co-propagating or counter-propagating light beams.

In some embodiments of the method 900, the diameter D of the first and second beams, the thickness t of the slab between the opposed surfaces, and an angle α of the first and second light beams w.r.t. a normal to the first and second surfaces (FIG. 3A) satisfy the condition (1) above, i.e. D≥t times tan(α). For two-beam illuminators, the condition may be D=t times tan(α). To improve the spatial uniformity of the output illumination, the first and second light beams emitted by the light source may be orthogonally polarized, e.g. orthogonally linearly or circularly polarized. The first and second light beam may propagate towards each other as illustrated in FIGS. 2 and 5, or may co-propagate in the slab as illustrated in FIG. 4.

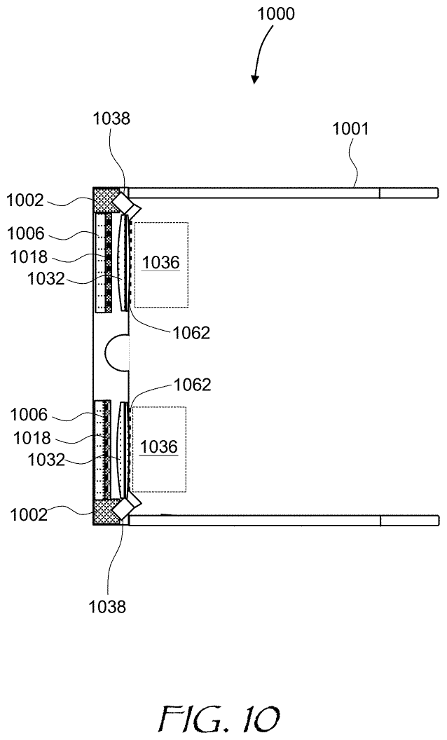

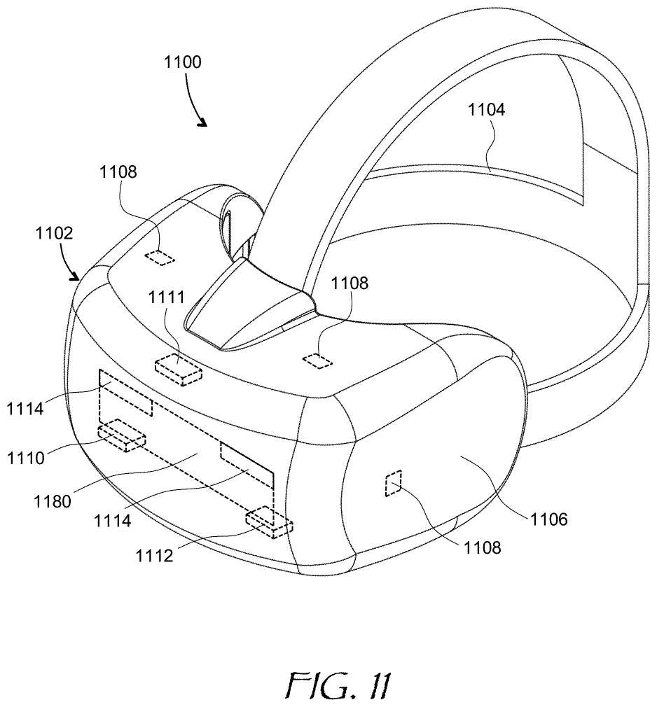

Turning to FIG. 10, an augmented reality (AR) near-eye display 1000 includes a frame 1001 supporting, for each eye: a light source 1002 including a beam-splitting grating and/or multiple directional sources as disclosed herein; a slab lightguide 1006 for guiding the light beam inside and out-coupling portions of the light beam as disclosed herein; a display panel 1018 illuminated by the light beam portions out-coupled from the slab lightguide 1006 for spatially modulating the light beam portions; an ocular lens 1032 for converting an image in linear domain displayed by the display panel 1018 into an image in angular domain at an eyebox 1036; an eye-tracking camera 1038; and a plurality of illuminators 1062 shown as black dots. The illuminators 1062 may be supported by ocular lens 1032 for illuminating an eyebox 1036.

The purpose of the eye-tracking cameras 1038 is to determine position and/or orientation of both eyes of the user to enable steering the image light to the locations of the user's eyes as disclosed herein. The illuminators 1062 illuminate the eyes at the corresponding eyeboxes 1036, to enable the eye-tracking cameras 1038 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with the light of the illuminators 1062, the light illuminating the eyeboxes 1036 may be made invisible to the user. For example, infrared light may be used to illuminate the eyeboxes 1036.

Turning to FIG. 11, an HMD 1100 is an example of an AR/VR wearable display system which encloses the user's face, for a greater degree of immersion into the AR/VR environment. The HMD 1100 may generate the entirely virtual 3D imagery. The HMD 1100 may include a front body 1102 and a band 1104 that can be secured around the user's head. The front body 1102 is configured for placement in front of eyes of a user in a reliable and comfortable manner. A display system 1180 may be disposed in the front body 1102 for presenting AR/VR imagery to the user. The display system 1180 may include any of the display devices and illuminators disclosed herein. Sides 1106 of the front body 1102 may be opaque or transparent.

In some embodiments, the front body 1102 includes locators 1108 and an inertial measurement unit (IMU) 1110 for tracking acceleration of the HMD 1100, and position sensors 1112 for tracking position of the HMD 1100. The IMU 1110 is an electronic device that generates data indicating a position of the HMD 1100 based on measurement signals received from one or more of position sensors 1112, which generate one or more measurement signals in response to motion of the HMD 1100. Examples of position sensors 1112 include: one or more accelerometers, one or more gyroscopes, one or more magnetometers, another suitable type of sensor that detects motion, a type of sensor used for error correction of the IMU 1110, or some combination thereof. The position sensors 1112 may be located external to the IMU 1110, internal to the IMU 1110, or some combination thereof.

The locators 1108 are traced by an external imaging device of a virtual reality system, such that the virtual reality system can track the location and orientation of the entire HMD 1100. Information generated by the IMU 1110 and the position sensors 1112 may be compared with the position and orientation obtained by tracking the locators 1108, for improved tracking accuracy of position and orientation of the HMD 1100. Accurate position and orientation is important for presenting appropriate virtual scenery to the user as the latter moves and turns in 3D space.

The HMD 1100 may further include a depth camera assembly (DCA) 1111, which captures data describing depth information of a local area surrounding some or all of the HMD 1100. The depth information may be compared with the information from the IMU 1110, for better accuracy of determination of position and orientation of the HMD 1100 in 3D space.

The HMD 1100 may further include an eye tracking system 1114 for determining orientation and position of user's eyes in real time. The obtained position and orientation of the eyes also allows the HMD 1100 to determine the gaze direction of the user and to adjust the image generated by the display system 1180 accordingly. The determined gaze direction and vergence angle may be used to adjust the display system 1180 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1102.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. An illuminator comprising:
a light source for providing first and second light beams;
a slab of transparent material for in-coupling the first and second light beams into the slab for propagation therein by a series of zigzag reflections from opposed surfaces of the slab along a length dimension of the slab; and
an out-coupler for out-coupling offset parallel portions of the first and second light beams from the slab along the length dimension, wherein the first light beam portions are offset from one another by a series of gaps spaced along the length dimension, and wherein the second light beam portions are offset from one another by a series of gaps spaced along the length dimension;
wherein the gaps between the first light beam portions overlap with the second light beam portions, and the gaps between the second light beam portions overlap with the first light beam portions, for providing a continuous illumination along the length dimension.

2. The illuminator of claim 1, wherein a diameter D of the first and second light beams, a thickness t of the slab between the opposed surfaces, and an angle α of the first and second light beams w.r.t. a normal to the first and second surfaces satisfy the condition t*tan(α)≥D.

3. The illuminator of claim 1, wherein a full width at half maximum (FWHM) of the gaps between the first light beam portions is substantially equal to a FWHM of the second light beam portions, and a FWHM of the gaps between the second light beam portions is substantially equal to a FWHM of the first light beam portions.

4. The illuminator of claim 1, wherein the first and second light beams emitted by the light source are orthogonally polarized.

5. The illuminator of claim 1, wherein the out-coupler comprises at least one of:
a polarization volume grating (PVH), a volume Bragg grating (VBG), or a surface-relief grating (SRG).

6. The illuminator of claim 5, wherein the out-coupler comprises a PVH, and wherein the first and second light beams emitted by the light source are orthogonally circularly polarized.

7. The illuminator of claim 6, wherein a thickness of the PVH varies along the length dimension of the slab for evening out optical power density of the illumination provided by the illuminator along the length dimension of the slab.

8. The illuminator of claim 1, wherein a coherence length of the light source is less than an optical path difference between neighboring optical paths of the first and second light beams.

9. The illuminator of claim 1, wherein the light source comprises a directional source for providing a directed light beam, and a grating coupled to the directional source for splitting the directed light beam into the first and second light beams at an angle to each other for joint propagation in the slab generally in a same direction along the length dimension of the slab.

10. The illuminator of claim 9, wherein the grating is tunable in pitch.

11. The illuminator of claim 1, wherein the light source comprises first and second directional sources for providing the first and second light beams respectively, wherein the first and second light beams are coupled at opposite edges of the slab to propagate towards each other.

12. The illuminator of claim 11, wherein the first and second directional sources are configured for edge-coupling the first and second light beams, respectively, into the slab to propagate towards each other.

13. A display device comprising:
a display panel for providing an image in linear domain; and
an illuminator for illuminating the display panel, the illuminator comprising:
a light source for providing first and second light beams;
a slab of transparent material for in-coupling the first and second light beams into the slab for propagation therein by a series of zigzag reflections from opposed surfaces of the slab along a length dimension of the slab; and
an out-coupler for out-coupling offset parallel portions of the first and second light beams from the slab along the length dimension, wherein the first light beam portions are offset from one another by a series of gaps spaced along the length dimension, and wherein the second light beam portions are offset from one another by a series of gaps spaced along the length dimension;
wherein the gaps between the first light beam portions overlap with the second light beam portions, and the gaps between the second light beam portions overlap with the first light beam portions, for providing a continuous illumination of the display panel along the length dimension.

14. The display device of claim 13, wherein a full width at half maximum (FWHM) of the gaps between the first light beam portions is substantially equal to a FWHM of the second light beam portions, and a FWHM of the gaps between the second light beam portions is substantially equal to a FWHM of the first light beam portions.

15. The display device of claim 13, wherein the light source comprises a directional source for providing a directional light beam; and
a grating coupled to the light source for splitting the directional light beam into the first and second light beams at an angle to each other for joint propagation in the slab generally in a same direction along the length dimension of the slab.

16. The display device of claim 13, wherein the light source comprises first and second directional sources for providing the first and second light beams respectively, wherein the first and second light beams are coupled at opposite edges of the slab to propagate towards each other.

17. A method for illuminating a display panel, the method comprising:
using a light source to provide first and second light beams;
in-coupling the first and second light beams into a slab of transparent material;
propagating the first and second light beams in the slab by a series of zigzag reflections from opposed surfaces of the slab along a length dimension of the slab; and
out-coupling offset parallel portions of the first and second light beams from the slab along the length dimension, wherein the first light beam portions are offset from one another by a series of gaps spaced along the length dimension, and wherein the second light beam portions are offset from one another by a series of gaps spaced along the length dimension;
wherein the gaps between the first light beam portions overlap with the second light beam portions, and the gaps between the second light beam portions overlap with the first light beam portions, for providing a continuous illumination of the display panel along the length dimension.

18. The method of claim 17, wherein a diameter D of the first and second light beams, a thickness t of the slab between the opposed surfaces, and an angle α of the first and second light beams w.r.t. a normal to the first and second surfaces satisfy the condition D≥t*tan(α).

19. The method of claim 17, wherein the first and second light beams emitted by the light source are orthogonally polarized.

20. The method of claim 17, wherein the first and second light beams are propagated in the slab towards each other.
